(19) United States
(12) Patent Application Publication
(10) Pub. No.: US 2024/0205657 A1
(43) Pub. Date: Jun. 20, 2024

(54) SYSTEM AND METHOD FOR PROVIDING LOCAL ASSISTANCE TO A CALLER WHOSE LOCATION IS UNKNOWN

(71) Applicant: MOTOROLA SOLUTIONS, INC., Chicago, IL (US)

(72) Inventors: HAIM KAHLON, Onyx (IL); GUY BURKO, Holon (IL); JACOB SHEM TOV, Jerusalem (IL)

(21) Appl. No.: 18/067,784

(22) Filed: Dec. 19, 2022

(51) Int. Cl. H04W 4/90; H04W 4/02; H04W 76/50

(52) U.S. Cl. CPC H04W 4/90; H04W 4/023; H04W 76/50

(57) ABSTRACT

Techniques for providing assistance to a caller whose location is unknown are provided. A request for assistance from a caller whose location is unknown is received at a public safety answering point from a calling device. A list of devices proximate to the calling devices is received from the calling device whose location is unknown. It is identified when a device in the list of devices proximate to the calling device has been registered as belonging to a person willing to provide local assistance. A request is sent to the identified device to provide local assistance to the caller whose location is unknown.

### BACKGROUND

Applications currently exist that allow for a person to register as a volunteer willing to assist in a public safety response. The person could register their mobile device (e.g. smartphone, etc.) and possibly even provide a list of skills they have (e.g. trained in cardiopulmonary resuscitation (CPR), trained in first aid, etc.). By registering their device, the person has indicated they are willing to provide local assistance if called upon and has agreed to have their location tracked to determine if they are local to a request for assistance.

In operation, a person in need of assistance may dial an emergency number (e.g. 911, 999, etc.) from a mobile device to be connected to a public safety answering point (PSAP). Through any combination of GPS, enhanced 911, or equivalents, the location of the device being used to request assistance is provided to the PSAP. PSAP personnel may then use the application to determine if there are any registered volunteers nearby the caller's location. If so, the PSAP may contact one or more of the registered volunteers through their registered device to request that local assistance be provided.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments

FIG. 1 is an example environment that may utilize the providing local assistance to a caller whose location is unknown according to the techniques described herein.

FIG. 2 is an example, environment for providing local assistance when no registered volunteers are available in the caller's location.

FIGS. 3A and 3B are an example flow chart for a PSAP that may implement the techniques described herein.

FIG. 4 is an example flow chart for a mobile caller device that may implement the techniques described herein.

FIG. 5 is an example of a device that may be utilized by a caller requesting local assistance.

FIG. 6 is an example of a device that may implement a PSAP.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Although the applications to provide local assistance are available, a problem arises in that these applications are dependent on knowing the location of both the user calling for assistance as well as the locations of the registered volunteers. These locations may be unknown for any number of reasons. Device location technologies can unreliable when indoors. Device location technologies are not very good when reporting locations at different elevations (e.g. differentiating between someone at the top floor of a skyscraper vs someone in the basement, etc.). GPS capabilities may vary between different mobile device types and/or locations. Enhanced 911 location services, although widely deployed, do not have ubiquitous coverage. What should be understood is that currently available local assistance applications that require location information do not function if the location of the caller and the registered volunteers is not known. In addition, if there are no registered volunteers in the caller's location, there is no one to contact to provide local assistance.

The provide local assistance to a caller whose location is unknown techniques described herein solve the problem that location information may not be available by providing a system wherein the local assistance request is not dependent on knowing the location of either the caller or the people being requested to provide local assistance. When a person calls an emergency number (e.g. 911, etc.) with their mobile device, the caller's mobile device will first use short range wireless communications technologies (e.g. Bluetooth™, etc.) to identify other mobile devices that are in the vicinity of the device calling the emergency number. The calling device may create a list of all device IDs (e.g. Bluetooth IDs) of the nearby devices. The call to the emergency number may then include this list of device IDs as data sent to the PSAP as part of the emergency call.

People who are willing to provide local assistance may register with the system as volunteers. As part of that registration process, a volunteer may provide information such as the IDs (e.g. Bluetooth™ ID, etc.) associated with their mobile device as well as contact information (e.g. phone number, etc.) of the device. Upon receipt of the emergency call, the PSAP may examine the list of device IDs included in the emergency call to determine if any device ID on the list is associated with a volunteer who has registered their device. If so, the PSAP may use the contact information provided as part of the registration process to contact the volunteer. The volunteer may be told that someone within their vicinity is in need of local assistance. If the person needing local assistance in not readily apparent to the volunteer (e.g. someone nearby experiencing visible distress, etc.), the PSAP call taker may instruct the caller to aid in identifying themselves (e.g. raise your hand, etc.).

In some cases, there may be no registered volunteer within the vicinity of the caller. In such cases, the PSAP may send a request to the caller's device to query all nearby devices for contact information (e.g. phone number, etc.). The nearby devices may optionally respond to the query with contact information. The contact information for all devices that responded may be sent to the PSAP as a list of contact information for nearby devices. A PSAP call taker may then contact each device in the list using the contact information and ask if the device owner would be willing to help the caller.

What should be clearly understood is that location information is not needed for either the calling device or for the registered volunteers. As such, the techniques described herein are suitable for locations (e.g. indoors, etc.) where location information is not readily available. Because the device IDs are obtained using short range wireless communications, it can be ensured that the identified volunteers are within a short distance (e.g. no further than the range of the short range wireless technology used) from the caller. Furthermore, the techniques also provide for the ability to request someone nearby volunteer to provide local assistance when there are no registered volunteers nearby.

A method of providing local assistance to a caller is provided. The method includes receiving, at a public safety answering point, a request for assistance from a caller whose location is unknown, the request for assistance received from a calling device. The method also includes receiving a list of devices proximate to the calling device from the calling device whose location is unknown. The method also includes identifying when a device in the list of devices proximate to the calling device has been registered as belonging to a person willing to provide local assistance. The method also includes sending a request to the identified device to provide local assistance to the caller whose location is unknown.

In one aspect, the method includes sending an indication to the calling device associated with the caller whose location is unknown to download a helper application, wherein the helper application collects the list of devices proximate to the calling device via a wireless connection and receiving, at the public safety answering point, from the helper application, the list of devices proximate to the calling device. In one aspect, the method includes receiving, at the public safety answering point, the list of devices proximate to the calling device from an application integrated with the calling device.

In one aspect of the method, the list of devices proximate to the calling device further comprises a list of Bluetooth identifiers, wherein identifying when a device in the list of devices proximate to the calling device has been registered as belonging to a person willing to provide local assistance further includes determining if the Bluetooth identifier is included in a list of people registered as willing to provide local assistance, wherein registration includes providing the Bluetooth identifier of the device. In one aspect, the method includes determining that there is no device in the list of devices proximate to the calling device that has been registered as belonging to a person willing to provide local assistance, sending a request to the calling device to solicit contact information for devices proximate to the calling device, receiving contact information for devices proximate to the calling device, and contacting a device proximate to the calling device using the contact information to request a user of the contacted device to provide local assistance to the caller whose location is unknown.

A method for requesting local assistance is provided. The method includes calling, with a calling device whose location cannot be determined, a public safety answering point to request local assistance. The method further includes identifying devices proximate to the calling device and adding the devices to a list of devices proximate to the calling device. The method further includes sending the list of devices proximate to the calling device to the public safety answering point, wherein the public safety answering point identifies a device within the list of devices that is associated with a user that has volunteered to provide local assistance.

In one aspect, the method includes receiving an indication to download a helper application, wherein the helper application collects the list of devices proximate to the calling device via a wireless connection and collecting, via the helper application over the wireless connection, devices proximate to the calling device. In one aspect, the method includes collecting, via an application integrated with the calling device over a wireless connection, devices proximate to the calling device.

In one aspect of the method, the list of devices proximate to the calling device further comprises a list of Bluetooth identifiers for each device in the list of proximate devices. In one aspect, the method further includes receiving a request to collect contact information from the list of devices proximate to the calling device, requesting contact information for each device within the list of devices proximate to the calling device, and sending the contact information for each device within the list of devices proximate to the calling device to the public safety answering point.

A system for providing local assistance to a caller is provided. The system includes a processor and a memory. The memory includes a set of instructions thereon that when executed by a processor cause the processor to receive, at a public safety answering point, a request for assistance from a caller whose location is unknown, the request for assistance received from a calling device. The instructions further cause the processor to receive a list of devices proximate to the calling device from the calling device whose location is unknown. The instructions further cause the processor to identify when a device in the list of devices proximate to the calling device has been registered as belonging to a person willing to provide local assistance. The instructions further cause the processor to send a request to the identified device to provide local assistance to the caller whose location is unknown.

In one aspect of the system, the instructions further cause the processor to send an indication to the calling device associated with the caller whose location is unknown to download a helper application, wherein the helper application collects the list of devices proximate to the calling device via a wireless connection and receive, at the public safety answering point, from the helper application, the list of devices proximate to the calling device. In one aspect of the system, the instructions further cause the processor to receive, at the public safety answering point, the list of devices proximate to the calling device from an application integrated with the calling device.

In one aspect of the system the list of devices proximate to the calling device further comprises a list of Bluetooth identifiers, wherein the instructions to identify when a device in the list of devices proximate to the calling device has been registered as belonging to a person willing to provide local assistance further comprises instructions to determine if the Bluetooth identifier is included in a list of people registered as willing to provide local assistance, wherein registration includes providing the Bluetooth identifier of the device. In one aspect of the system the instructions further cause the processor to determine that there is no device in the list of devices proximate to the calling device that has been registered as belonging to a person willing to provide local assistance, send a request to the calling device to solicit contact information for devices proximate to the calling device, receive contact information for devices proximate to the calling device, and contact a device proximate to the calling device using the contact information to request a user of the contacted device to provide local assistance to the caller whose location is unknown.

Further advantages and features consistent with this disclosure will be set forth in the following detailed description, with reference to the figures.

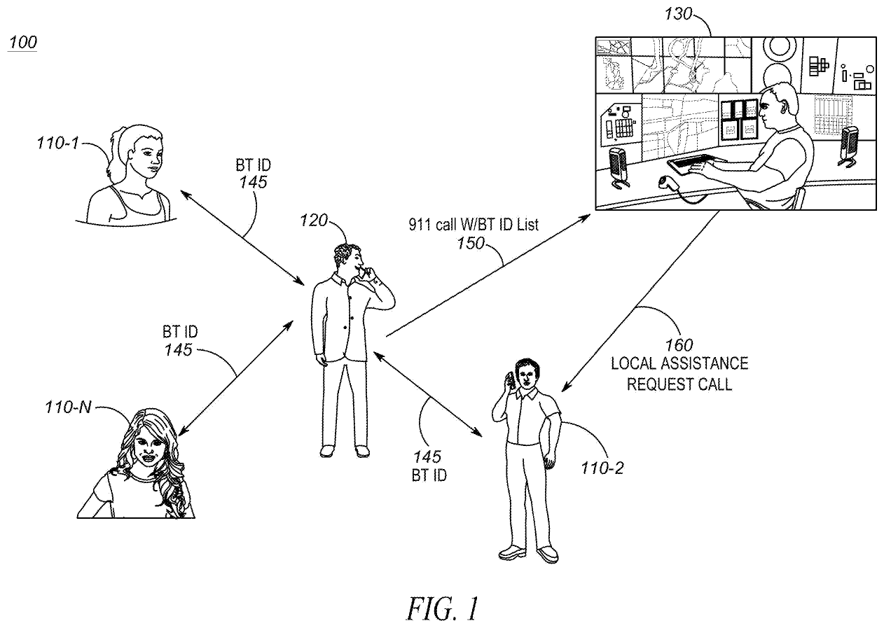

FIG. 1 is an example environment 100 that may utilize the providing local assistance to a caller whose location is unknown according to the techniques described herein. Environment 100 may include registered volunteers 110-1, 2, unregistered persons 110-N, unknown location caller 120, and PSAP 130.

The registered volunteers 110-1,2 may be people who have volunteered to provide local assistance to people who are requesting assistance from a PSAP. As part of the registration process, the volunteers may provide certain information that may be used to request local assistance. For example, the volunteers may provide short range wireless device IDs that are associated with their mobile device (e.g. smartphone, etc.). One example short range wireless technology that may be used is Bluetooth™ and the device ID may be a Bluetooth™ ID. It should be understood that this is simply an example technology and that any other short range wireless technology (e.g. WiFi, etc.) would also be suitable for use with the techniques described herein. When registering, the volunteers may also provide mobile device contact information (e.g. phone number, etc.) that may be used to contact the volunteer when needed. Unregistered persons 110-N may be all people who have not registered to be volunteers.

Unknown location caller 120 may be any caller to a PSAP 130 that is requesting assistance. The unknown location caller 120 may not know the location for any number of reasons. For example, the caller is indoors, has insufficient reception for GPS to function, is not in an enhanced 911 covered area, etc. In some cases, the caller themselves might not be able to provide location information. For example, the caller may be a child who is lost, a disoriented elderly person, a cognitively impaired person, etc. What should be understood is that the location of the caller is unknown.

The PSAP 130 may be any call center that receives calls from people calling an emergency number. The PSAP 130 may receive these calls and dispatch appropriate resources (e.g. police, fire, emergency medical services, etc.). In some cases, the appropriate resource may be a person who has volunteered to provide local assistance and who is in short range wireless communication range of the unknown location caller.

In operation, the unknown location caller 120 may be experiencing a situation for which assistance is needed. The particular situation is relatively unimportant. It could be a minor situation such as the unknown location caller 120 is a child that has become separated from their parents or a more severe situation such as the person may be experiencing a heart attack. The unknown location caller 120 may then use his mobile device (e.g. smartphone, etc.) to make an emergency call to the PSAP 130 to request assistance.

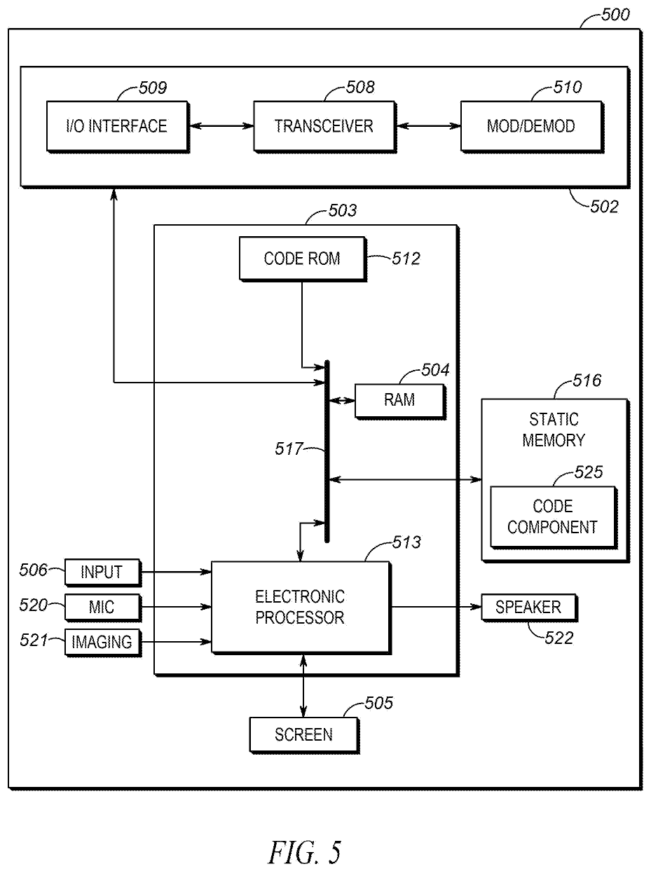

Modern mobile devices, an example of which is described with respect to FIG. 5, include emergency calling applications that are integrated with the device. Such emergency application capabilities (e.g. Next Generation 911, etc.) are internet protocol based and allow for transmission of data between the calling device and the PSAP. The integrated application may also include the ability to gather data from devices that are in proximity to the unknown location caller 120, as will be described in further detail below. The integrated application can send the information that is gathered from devices in proximity to the unknown caller location directly to the PSAP (just as it can send location information, when available, directly to the PSAP).

Although the capabilities to communicate information from the calling device integrated emergency calling application has been mentioned, not all devices may have such functionality integrated. In some cases, the PSAP 130 may instruct the unknown location caller device to download a helper application that provides capabilities equivalent to those that would be present in the integrated emergency calling application. For example, the PSAP 130 may send a text message including a link to the helper application download to the caller's device and instruct the caller to click on the link to download the helper application. For ease of description, the remained of this description will be described in terms of an integrated emergency calling application, but it should be understood the same functionality could also be provided by a helper application.

The emergency call application may utilize a short range wireless communication technology to identify other devices that are within wireless range of the unknown location caller 120. For example, most modern communications devices include Bluetooth™ short range wireless communications. The unknown location caller's mobile device may attempt to open a Bluetooth™ connection with all nearby devices to retrieve the Bluetooth ID 145 of those devices. As shown, volunteers 110-1,2 are within wireless connection range, and each provide their Bluetooth™ ID. Unregistered person 110-N is also within range and may provide their Bluetooth™ ID. Although Bluetooth™ has been described, it should be understood that the techniques described herein are suitable for use with any short range wireless communications technology that provides an ID that can be associated with a mobile device.

The emergency call application may collect the device IDs retrieved from all the devices proximate to the unknown location caller's device and within the range of the wireless communications link into a list and send that list 150 to the PSAP 130.

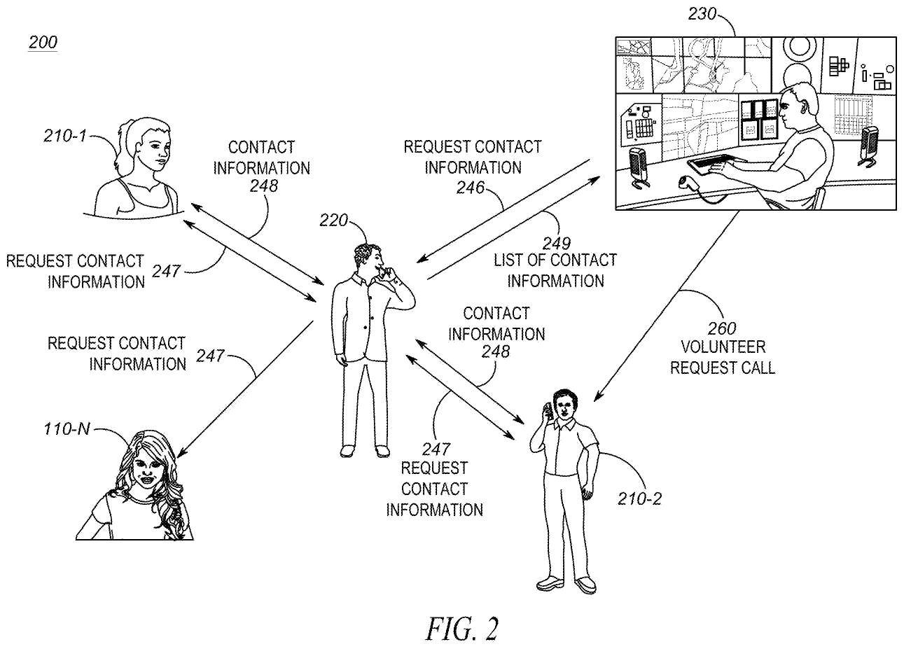

Upon receipt of the list, the PSAP 130 may examiner each device ID in the list to determine if it is a device ID associated with a person who has previously registered to volunteer to provide local assistance. If no such device ID is found, a process to solicit volunteers is executed. The process to solicit volunteers is described in further detail with respect to FIG. 2.

If it is determined that a device ID in the list is associated with the mobile device of a person who has registered to volunteer to provide local assistance, the PSAP 130 may initiate a local assistance request call 160 to that device using the contact information provided for the device during the registration process. In the present example, the volunteer 110-2 may receive the request for local assistance via a phone call. However, it should be understood the request could come in other forms as well (e.g. text message, etc.). What should be understood is the contact information is used to connect the PSAP with the registered volunteer to request local assistance. Although in this example the request is sent to a single registered volunteer that is nearby, it should be understood that the request could also be sent to more than one, or even all devices that are associated with people who have registered to provide local assistance and are in close proximity with the unknown location caller.

FIG. 2 is an example environment 200 for providing local assistance when no registered volunteers are available in the caller's location. FIG. 2 describes a continuation of the scenario described in FIG. 1, when none of the users of devices proximate to the unknown location caller have previously registered as volunteers to provide local assistance. Environment 200 includes people 210-1 . . . N, none of whom have volunteered to provide local assistance. Environment 200 also include unknown location caller 220 who has called the emergency number to request assistance and no local volunteers were found. Environment 200 also includes the PSAP 130.

Upon determining that there are no users proximate to the unknown location caller 220 who have volunteered to provide local assistance, the PSAP 130 may send a request contact information 246 message to the caller's device. This may cause the integrated emergency call application (or downloaded helper application) to utilize the short range wireless connection to send a request for contact information 247 to all devices within range of the short range wireless connection. The contact information will be information that may be used to contact the non-volunteer's devices (e.g. phone numbers, etc.).

It should be noted that the non-volunteer's mobile devices 210-1 . . . N do not necessarily need to provide contact information. In some implementations, the request for contact information may case a notification (e.g. Bluetooth™ connect request, text message, etc.) indicating that contact information for the device has been requested. The notification may allow the user to decide if they wish to provide contact information. In the present example, user 210-1, 2 have decided to provide contact information 248, while user 210-N has decided not to provide contact information.

The unknown location caller's 220 device may then send a list of all contact information received (if any) to the PSAP 230. The PSAP 230 may select at least one of the device's contact information from the list and make a volunteer request call 260 to the device. The PSAP call taker may explain to whoever answers the call that there is someone nearby, possibly a vulnerable person, who is in need of local assistance. The PSAP call taker may ask the person if they are willing to provide local assistance. If so, the PSAP call take may provide instructions to provide local assistance. If the person does not wish to provide local assistance, the PSAP call taker may move to the next device on the list. This process may continue until either someone accepts the request to provide local assistance or there are no more devices in the list.

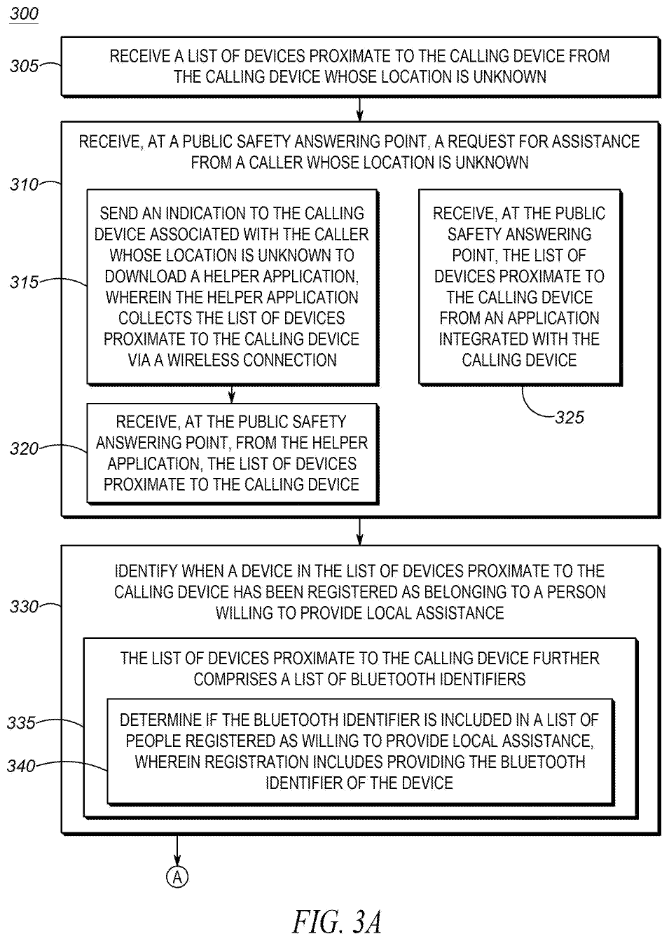

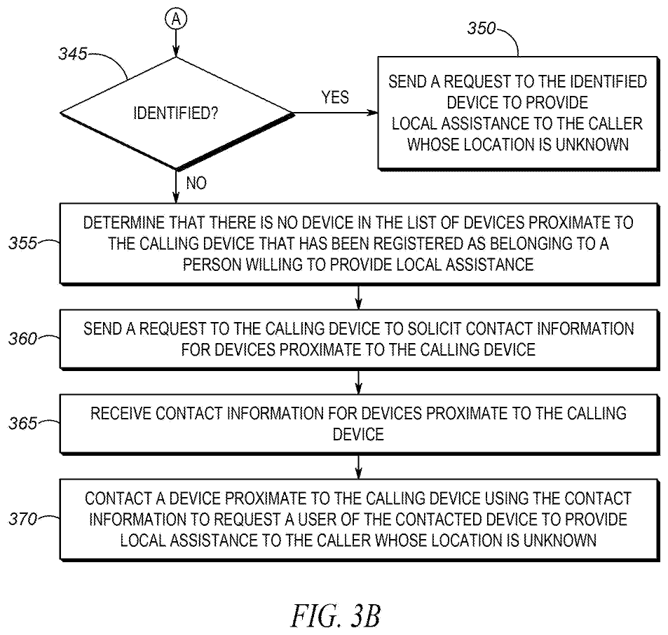

FIGS. 3A and 3B are an example flow chart 300 for a PSAP that may implement the techniques described herein. In block 305, a request for assistance from a caller whose location is unknown may be received at a public safety answering point. The caller's location may be unknown for any number of reasons such as being indoors, insufficient GPS signal, not in an enhanced 911 equipped area, etc. What should be understood is the caller's location is unknown.

In block 310, a list of devices proximate to the calling device may be received from the calling device whose location is unknown. As explained above, the calling device may be equipped with a short range wireless communications technology that allows communication with other devices that are within range. An example of such technology may be Bluetooth™, however the techniques described herein are not so limited. A device that is proximate to the calling device is any device within range of the short range wireless connection.

In one possible implementation, there is a helper application downloaded to the caller device that is used to gather the device IDs of nearby devices. In block 315, an indication is sent to the calling device associated with the caller whose location is unknown to download a helper application. The helper application collects the list of devices proximate to the calling device via a wireless connection. In other words, the helper application utilizes the short range wireless communications capability of the mobile device to connect and receive information for all devices within communications range.

In block 320, the list of devices proximate to the calling device is received at the public safety answering point from the helper application. After collecting the list of nearby devices, the helper application may send that list to the public safety answering point.

In another implementation, the list of devices nearby the calling device is collected by an emergency calling application integrated within the phone. As described above, modern communications devices include an integrated application that may be utilized to communicate with public safety answering points. This application includes the ability to transmit data as well as voice to the public safety answering point. In block 325, the list of devices proximate to the calling device is received at the public safety answering point, from an application integrated with the calling device.

In block 330, it may be identified when a device in the list of devices proximate to the calling device has been registered as belonging to a person willing to provide local assistance. As explained above, people may be willing to volunteer to provide local assistance and may register their devices. This registration information may include a device identifier of the device associated with the volunteer. If the list of proximate devices includes a device that has been registered, then it is known that the owner of that device has volunteered to provide local assistance.

In block 335, the list of devices proximate to the calling device further comprises a list of Bluetooth identifiers. As explained above, Bluetooth™ may be one type of short range wireless communications technology that may be utilized to implement the techniques described herein, although the techniques are not limited to a Bluetooth™ implementation. In block 340, it may be determined if the Bluetooth identifier is included in a list of people registered as willing to provide local assistance, wherein registration includes providing the Bluetooth identifier of the device. In other words, if the Bluetooth™ identifier was included as part of the volunteer registration process, this means that the device is now located proximate to someone who is requesting local assistance.

In block 345, it may be determined if any devices were identified in block 330. If so, the process moves to block 350. In block 350, a request may be sent to the identified device to provide local assistance to the caller whose location is unknown. The request may be in the form of a phone call, a text message, or any other type of communications mechanism. Providing a communications method (e.g. phone number, etc.) may be part of the process of registering as a volunteer. Because the user has volunteered to provide local assistance, it is expected that the recipient of the request to provide local assistance would be receptive to the request.

When it is determined in block 345 that no devices proximate to the caller whose location is unknown are associated with a registered volunteer, the system may attempt to find someone who is not already registered to provide local assistance but is in proximity to the caller, so that they can request local assistance from that person. In block 355, it is determined that there is no device in the list of devices proximate to the calling device that has been registered as belonging to a person willing to provide local assistance. This means that there are no volunteers currently close enough the caller's location to provide local assistance.

In block 360, a request is sent to the calling device to solicit contact information for devices proximate to the calling device. The request may be sent over the same wireless communications technology (e.g. Bluetooth™, etc.) that was used to obtain the list of devices proximate to the calling device. Contact information can include information that can be used to establish a connection between the public safety answering point and a user of a device proximate to the caller. For example, contact information may include a telephone number.

In block 365, contact information for devices proximate to the calling device may be received. The caller's device may send the request for contact information to all proximate devices and receive contact information from at least some of the proximate devices. The caller's device may send this list of contact information for proximate devices to the PSAP. It should be understood that not all proximate devise may be willing to provide contact information.

In block 370, a device proximate to the calling device may be contacted using the contact information to request a user of the contacted device to provide local assistance to the caller whose location is unknown. In other words, a person who has not previously registered as a volunteer willing to provide local assistance may be recruited at the time of the call when no other volunteers are available.

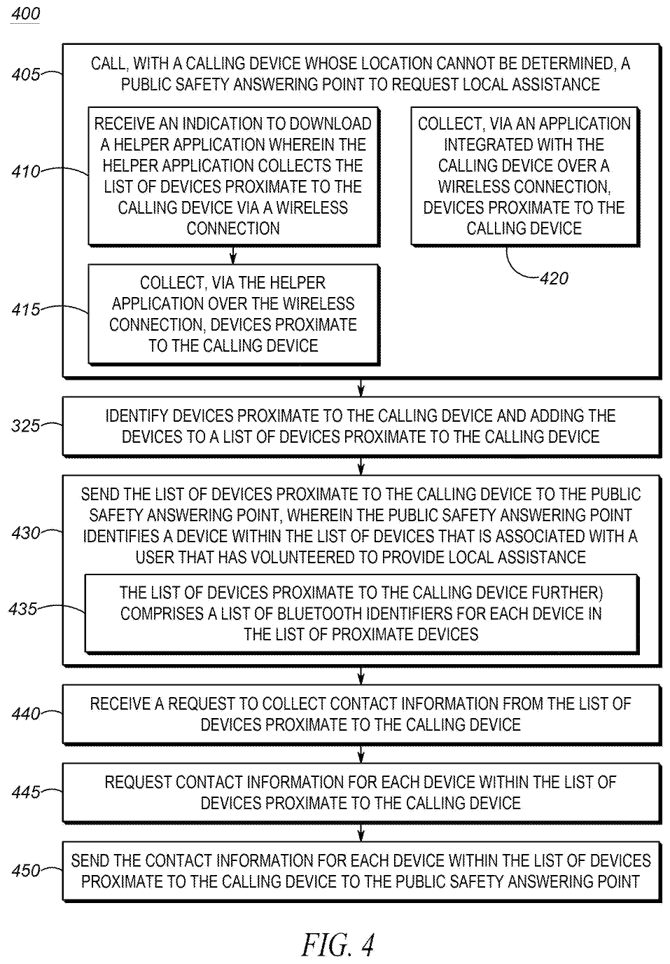

FIG. 4 is an example flow chart for a mobile caller device that may implement the techniques described herein. In block 405, a calling device whose location cannot be determined may call a public safety answering point to request local assistance. The particular reason for the call is unimportant. What should be understood is that the calling device is calling the public safety answering point in order to request assistance.

In one implantation, the calling device may need to download a helper application to perform the steps that are described in further detail below. In block 410, an indication to download a helper application may be received. The helper application collects the list of devices proximate to the calling device via a wireless connection. For example, the helper application may use a short range wireless connection on the calling device to request information from proximate devices.

In block 415, the helper application may collect, over the wireless connection, devices proximate to the calling device. Proximate devices are those devices within range of the short range wireless connection of the calling device. These devices may be devices operated by individuals who may be able to provide local assistance to the caller whose location is unknown.

In another implementation, the functionality provided by the helper application may be integrated within an emergency calling application that is integrated with the mobile device. The integrated application may be used to send data (e.g. list of identified proximate devices) to the public safety answering point. In block 420, an application integrated with the calling device may collect, over a wireless connection, devices proximate to the calling device

In block 425, devices proximate to the calling device may be identified and added to a list of devices proximate to the calling device. The list therefore includes all devices that are within range of the short range wireless connection and could potentially be devices associated with users who are able to provide local assistance.

In block 430, the list of devices proximate to the calling device may be sent to the public safety answering point. The public safety answering point identifies a device within the list of devices that is associated with a user that has volunteered to provide local assistance. As explained above, when registering, as a volunteer, the volunteer provides their mobile device identification information, which may later be used to identify volunteers.

In one implementation, the short range wireless communications is provided by a Bluetooth™ connection. In block 435, the list of devices proximate to the calling device further comprises a list of Bluetooth identifiers for each device in the list of proximate devices. Although Bluetooth™ has been mentioned, it should be understood that the techniques described herein are suitable for use with any short range wireless connection technology. What should be understood is that the wireless connection ensures that only devices within proximity to the calling device are included.

In some cases, it may turn out that there are no register volunteers in proximity of the calling device. In block 440, a request may be received to collect contact information from the list of devices proximate to the calling device. In other words, the public safety answering point may not have been able to identify any devices belonging to registered volunteers and as such is going to try and find someone else to volunteers.

In block 445, contact information for each device within the list of devices proximate to the calling device may be requested. For example, the calling device may send a request for contact information (e.g. telephone number) to all devices that are within proximity to the calling device over the wireless connection. It should be understood that all the devices within proximity may not respond with contact information. In some implementations, the operator of the proximate devices may be asked if they wish to provide contact information.

In block 450, the contact information for each device within the list of devices proximate to the calling device is sent to the public safety answering point. It should be understood that this means that contact information is provided for those devices which responded to the request in block 445. The PSAP may then use this contact information to attempt to contact users of the proximate devices to as if they are willing to provide local assistance.

FIG. 5 is an example of a device 500 that may be utilized by a caller requesting local assistance. Similar devices may also be used by the people in locations proximate to the calling device. The device 500 may be, for example, embodied in the devices used by the caller whose location is unknown 120 and the registered and unregistered users 110-1 . . . N. Communication device 500 may be a distributed communication device across two or more of the foregoing (or multiple of a same type of one of the foregoing) and linked via a wired and/or wireless communication link(s). In some embodiments, the communication device 500 (for example, the mobile device of the unknown location caller) may be communicatively coupled to other devices such as the PSAP 130.

While FIG. 5 represents the communication devices described above with respect to FIGS. 1 and 2, depending on the type of the communication device, the communication device 500 may include fewer or additional components in configurations different from that illustrated in FIG. 5. For example, in some embodiments, communication device 500 acting as the infrastructure may not include one or more of the screen 505, input device 506, microphone 520, imaging device 521, and speaker 522. As another example, in some embodiments, the communication device 500 acting as the radio may further include a location determination device (for example, a global positioning system (GPS) receiver). Other combinations are possible as well. In general, communications device 500 includes the features provided by current mobile communications devices, such as smartphones.

As shown in FIG. 5, communication device 500 includes a communications unit 502 coupled to a common data and address bus 517 of a processing unit 503. The communication device 500 may also include one or more input devices (e.g., keypad, pointing device, touch-sensitive surface, etc.) 506 and an electronic display screen 505 (which, in some embodiments, may be a touch screen and thus also act as an input device 506), each coupled to be in communication with the processing unit 503.

The microphone 520 may be present for capturing audio from a user and/or other environmental or background audio that is further processed by processing unit 503 in accordance with the remainder of this disclosure and/or is transmitted as voice or audio stream data, or as acoustical environment indications, by communications unit 502 to other portable radios and/or other communication devices. The imaging device 521 may provide video (still or moving images) of an area in a field of view of the communication device 500 for further processing by the processing unit 503 and/or for further transmission by the communications unit 502. A speaker 522 may be present for reproducing audio that is decoded from voice or audio streams of calls received via the communications unit 502 from other portable radios, from digital audio stored at the communication device 500, from other ad-hoc or direct mode devices, and/or from an infrastructure RAN device, or may playback alert tones or other types of pre-recorded audio.

The processing unit 503 may include a code Read Only Memory (ROM) 512 coupled to the common data and address bus 517 for storing data for initializing system components. The processing unit 503 may further include an electronic processor 513 (for example, a microprocessor or another electronic device) coupled, by the common data and address bus 517, to a Random Access Memory (RAM) 504 and a static memory 516.

The communications unit 502 may include one or more wired and/or wireless input/output (I/O) interfaces 509 that are configurable to communicate with other communication devices, such as the radios 140, 145, and 150, and the wireless RAN 115.

For example, the communications unit 502 may include one or more wireless transceivers 508, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network.

The communications unit 502 may additionally or alternatively include one or more wireline transceivers 508, such as an Ethernet transceiver, a USB transceiver, or similar transceiver configurable to communicate via a twisted pair wire, a coaxial cable, a fiber-optic link, or a similar physical connection to a wireline network. The transceiver 508 is also coupled to a combined modulator/demodulator 510.

The electronic processor 513 has ports for coupling to the display screen 505, the input device 506, the microphone 520, the imaging device 521, and/or the speaker 522. Static memory 516 may store operating code 525 for the electronic processor 513 that, when executed, performs one or more of the steps set forth in blocks 405-450 and accompanying text. The static code may include an integrated emergency calling application that carries out the steps described above or may include code that implements the helper application functionality similarly described above.

The static memory 516 may comprise, for example, a hard-disk drive (HDD), an optical disk drive such as a compact disk (CD) drive or digital versatile disk (DVD) drive, a solid state drive (SSD), a flash memory drive, or a tape drive, and the like.

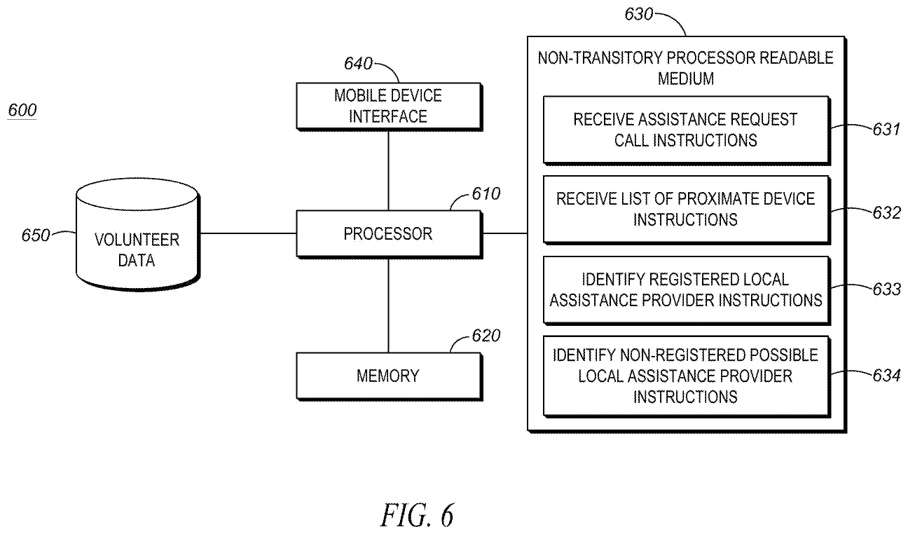

FIG. 6 is an example of a device 600 that may implement a PSAP. It should be understood that FIG. 6 represents one example implementation of a computing device that utilizes the techniques described herein. Although only a single processor is shown, it would be readily understood that a person of skill in the art would recognize that distributed implementations are also possible. For example, the various pieces of functionality described above (e.g. receiving lists of proximate devices, identifying volunteers, etc.) could be implemented on multiple devices that are communicatively coupled. FIG. 6 is not intended to imply that all the functionality described above must be implemented on a single device.

Device 600 may include processor 610, memory 620, non-transitory processor readable medium 630, mobile device interface 640, and volunteer data 650.

Processor 610 may be coupled to memory 620. Memory 620 may store a set of instructions that when executed by processor 610 cause processor 610 to implement the techniques described herein. Processor 610 may cause memory 620 to load a set of processor executable instructions from non-transitory processor readable medium 630. Non-transitory processor readable medium 630 may contain a set of instructions thereon that when executed by processor 610 cause the processor to implement the various techniques described herein.

For example, medium 630 may include receive assistance request call instructions 631. The receive assistance request call instructions 631 may cause the processor to receive a call from a caller whose location in unknown via the mobile device interface. The mobile device interface 640 may simply be a telephone connection that allows the PSAP to communication with mobile devices such as smartphones, etc. The receive assistance request call instructions 631 are described throughout this description generally, including places such as the description of block 305.

The medium 630 may include receive list of proximate device instructions 632. The receive list of proximate device instructions 632 may cause the processor to receive a list of devices that are proximate to the caller whose location is unknown from the calling device. The list of proximate devices may be received via the mobile device interface 640. The receive list of proximate device instructions 632 are described throughout this description generally, including places such as the description of blocks 310-325.

The medium 630 may include identify registered local assistance provider instructions 633. The identify registered local assistance provider instructions 633 may cause the processor to determine if any device in the list of devices is associated with a registered local assistance provider. For example, the processor may use a volunteer data 650 store, where registration information for volunteers may be stored, to determine if any device within the list of received devices is associated with a volunteer. If so, the volunteer may be contacted via the mobile device interface 640. The identify registered local assistance provider instructions 633 are described throughout this description generally, including places such as the description of blocks 330-350.

The medium 630 may include identify non-registered possible local assistance provider instructions 634. The identify non-registered possible local assistance provider instructions 634 may cause the processor to request, via the mobile device of the caller whose location is unknown, a list of contact information for all devices that are proximate to the calling device. Once received from the calling device, the processor may use the contact information to contact unregistered devices to determine if any device is associated with a user willing to provide local assistance. The identify non-registered possible local assistance provider instructions 634 are described throughout this description generally, including places such as the description of blocks 355-370.

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot create a wireless connection to a communications device to request or receive device identification information or contact information from mobile devices proximate to a calling device, among other features and functions set forth herein). Furthermore, the techniques described herein are integrated into the practical application of providing for local assistance for a caller when their location is unknown.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of providing local assistance to a caller comprising:
receiving, at a public safety answering point, a request for assistance from a caller whose location is unknown, the request for assistance received from a calling device;
receiving a list of devices proximate to the calling device from the calling device whose location is unknown;
identifying when a device in the list of devices proximate to the calling device has been registered as belonging to a person willing to provide local assistance; and
sending a request to the identified device to provide local assistance to the caller whose location is unknown.

2. The method of claim 1 further comprising:
sending an indication to the calling device associated with the caller whose location is unknown to download a helper application, wherein the helper application collects the list of devices proximate to the calling device via a wireless connection; and
receiving, at the public safety answering point, from the helper application, the list of devices proximate to the calling device.

3. The method of claim 1 further comprising:
receiving, at the public safety answering point, the list of devices proximate to the calling device from an application integrated with the calling device.

4. The method of claim 1 wherein the list of devices proximate to the calling device further comprises a list of Bluetooth identifiers, wherein identifying when a device in the list of devices proximate to the calling device has been registered as belonging to a person willing to provide local assistance further comprises:
determining if the Bluetooth identifier is included in a list of people registered as willing to provide local assistance, wherein registration includes providing the Bluetooth identifier of the device.

5. The method of claim 1 further comprising:
determining that there is no device in the list of devices proximate to the calling device that has been registered as belonging to a person willing to provide local assistance;
sending a request to the calling device to solicit contact information for devices proximate to the calling device;
receiving contact information for devices proximate to the calling device; and
contacting a device proximate to the calling device using the contact information to request a user of the contacted device to provide local assistance to the caller whose location is unknown.

6. A method for requesting local assistance comprising:
calling, with a calling device whose location cannot be determined, a public safety answering point to request local assistance;
identifying devices proximate to the calling device and adding the devices to a list of devices proximate to the calling device; and
sending the list of devices proximate to the calling device to the public safety answering point, wherein the public safety answering point identifies a device within the list of devices that is associated with a user that has volunteered to provide local assistance.

7. The method of claim 6 further comprising:
receiving an indication to download a helper application, wherein the helper application collects the list of devices proximate to the calling device via a wireless connection; and
collecting, via the helper application over the wireless connection, devices proximate to the calling device.

8. The method of claim 6 further comprising:
collecting, via an application integrated with the calling device over a wireless connection, devices proximate to the calling device.

9. The method of claim 6 wherein the list of devices proximate to the calling device further comprises a list of Bluetooth identifiers for each device in the list of proximate devices.

10. The method of claim 6 further comprising:
receiving a request to collect contact information from the list of devices proximate to the calling device;
requesting contact information for each device within the list of devices proximate to the calling device; and
sending the contact information for each device within the list of devices proximate to the calling device to the public safety answering point.

11. A system for providing local assistance to a caller comprising:
a processor; and
a memory coupled to the processor, the memory containing a set of instructions thereon that when executed by the processor cause the processor to:
receive, at a public safety answering point, a request for assistance from a caller whose location is unknown, the request for assistance received from a calling device;
receive a list of devices proximate to the calling device from the calling device whose location is unknown;
identify when a device in the list of devices proximate to the calling device has been registered as belonging to a person willing to provide local assistance; and
send a request to the identified device to provide local assistance to the caller whose location is unknown.

12. The system of claim 11 further comprising instructions to:
send an indication to the calling device associated with the caller whose location is unknown to download a helper application, wherein the helper application collects the list of devices proximate to the calling device via a wireless connection; and
receive, at the public safety answering point, from the helper application, the list of devices proximate to the calling device.

13. The system of claim 11 further comprising instructions to:
receive, at the public safety answering point, the list of devices proximate to the calling device from an application integrated with the calling device.

14. The system of claim 11 wherein the list of devices proximate to the calling device further comprises a list of Bluetooth identifiers, wherein the instructions to identify when a device in the list of devices proximate to the calling device has been registered as belonging to a person willing to provide local assistance further comprises instructions to:
determine if the Bluetooth identifier is included in a list of people registered as willing to provide local assistance, wherein registration includes providing the Bluetooth identifier of the device.

15. The method of claim 11 further comprising instructions to:
determine that there is no device in the list of devices proximate to the calling device that has been registered as belonging to a person willing to provide local assistance;
send a request to the calling device to solicit contact information for devices proximate to the calling device;
receive contact information for devices proximate to the calling device; and
contact a device proximate to the calling device using the contact information to request a user of the contacted device to provide local assistance to the caller whose location is unknown.
